(19) United States
(12) Patent Application Publication
(10) Pub. No.: US 2021/0291450 A1
(43) Pub. Date: Sep. 23, 2021

(54) FUSING IN THREE-DIMENSIONAL (3D) PRINTING

(71) Applicant: HEWLETT-PACKARD DEVELOPMENT COMPANY, L.P., Spring, TX (US)

(72) Inventor: Arthur H. BARNES, Vancouver, WA (US)

(21) Appl. No.: 16/608,242

(22) PCT Filed: Dec. 19, 2017
(86) PCT No.: PCT/US2017/067191

§ 371 Date: Oct. 25, 2019

(51) Int. Cl. B29C 64/286; B33Y 10/00; B33Y 30/00; B28B 1/00; B29C 64/165; B22F 10/14; B22F 12/41; B22F 12/45; B22F 12/49; B22F 12/13; B29C 64/295; B29C 64/277

(52) U.S. Cl. CPC B29C 64/286; B33Y 10/00; B33Y 30/00; B28B 1/001; B29C 64/165; B29C 64/277; B22F 12/41; B22F 12/45; B22F 12/49; B22F 12/13; B29C 64/295; B22F 10/14

(57) ABSTRACT

In an example implementation, a fusing module for use in a 3D printing system includes a thermic source to emit light rays for heating a target zone. The fusing module also includes a reflector associated with the thermic source to reflect upward-emitted light rays in a downward direction toward the target zone, and an absorber positioned above the thermic source to absorb light rays that reflect off of the target zone.

### BACKGROUND

Three-dimensional (3D) printers can produce 3D parts by providing a layer-by-layer accumulation and solidification of build material patterned from digital models. In different 3D printing examples, inkjet printheads can selectively print (i.e., apply, deliver) liquids such as fusing agents and binder fluids onto layers of build material within patterned areas of each layer. In one such example, binder fluids can penetrate and react with the build material to cause solidification of the material within the printed areas. In another example, liquid fusing agent printed on build material can absorb energy that causes the printed areas of build material to heat up and fuse together when the layers of build material are exposed to a fusing energy source.

### BRIEF DESCRIPTION OF THE DRAWINGS

Examples will now be described with reference to the accompanying drawings, in which:

FIG. 1a shows a simplified block diagram of an example three-dimensional (3D) part-forming device, implemented as a 3D printer;

FIG. 1b shows an example of a fusing module as a stand-alone unit; and,

FIG. 2 is a flow diagram showing example methods of applying fusing energy in a 3D printing system.

Throughout the drawings, identical reference numbers designate similar, but not necessarily identical, elements.

### DETAILED DESCRIPTION

In some examples of 3D printing, parts can be formed from digital models through a layer-by-layer accumulation and solidification of build material. Data from a digital model can be processed to generate 2D slices of parallel planes of the model. Each 2D slice can define a portion of a layer of build material as a “part area” that is to be solidified. Build material is generally referred to herein as being powdered build material, such as powdered nylon. However, there is no intent to limit the form or type of build material that may be used when producing a 3D object from a 3D digital object model. Various forms and types of build materials may be appropriate and are contemplated herein. Examples of different forms and types of build materials can include, but are not limited to, short fibers that have been cut into short lengths or otherwise formed from long strands or threads of material, and various powder and powder-like materials including plastics, ceramics, metals, and the like.

In some examples of fusing-based 3D printing processes, layers of build material (e.g., powder) can be spread over a platform or print bed within a build area of a 3D printing device. A liquid fusing agent can be selectively printed on, or otherwise applied to, each layer of build material in patterned areas according to a 2D slice of a part or parts. The areas of build material where fusing agent is printed define part areas that will be fused together and solidified to form a part or parts. Areas of build material left bare, or without fusing agent, are non-part areas that will not be fused. In some examples, suitable fusing agents can include ink-type formulations comprising carbon black, and other dye-based and/or pigment-based colored inks that can act as infra-red light absorbers, near infra-red light absorbers, and visible light absorbers. Other suitable fusing agents may also be available and are contemplated herein. In some examples, a detailing agent can be selectively applied around part contours to improve the part resolution. Detailing agents can include various fluids such as water, silicon, oil, or other fluids that can be applied to the build material to thermally and/or mechanically inhibit the build material from fusing, for example, as other nearby build material areas are being fused.

In fusing-based 3D printing processes, once the fusing and detailing agents have been printed or applied onto a layer of build material, the layer of build material can be exposed to a fusing energy source to cause the printed build material (i.e., the “part areas”) to fuse or melt. A fusing energy source is sometimes referred to as a fusing module. In some examples, a fusing module can include a number of thermic light sources or fusing lamps, such as quartz-tungsten infrared halogen lamps. The layer-by-layer process of spreading build material, printing liquid agents, and applying fusing energy, can be repeated, one layer at a time until a 3D part or 3D parts have been formed within the build area.

In some example fusing-based 3D printing processes, an inconsistent application of fusing energy onto the layers of build material can occur. The build material often comprises a white, or light-colored, powder material that can cause considerable back reflections or multi-scattering if the light does not strike a “part area” where fusing agent has been applied. Thus, an inconsistent application of energy can be due to an interaction between the fusing energy source (i.e., the fusing module) and the arrangement and/or geometry of parts being formed within the build area. More specifically, light emitted from fusing lamps within the fusing module may not strike the build material layer on a “part area” where it will be absorbed. Instead, some light may strike a “non-part area” of the build material that does not have fusing agent applied, causing the light to reflect off of the build material. Such back reflections of light can eventually reflect back to the build material and cause variations in irradiance and radiant exposure to the parts being formed within the build area.

Because irradiance comprises the amount of power being applied to build material to heat and fuse the parts, variations in the irradiance can cause inconsistent heating and fusing of parts and/or portions of parts. Inconsistent heating can cause variations in the formation of parts, including dimensional variations, cosmetic or appearance variations, material property variations, and a general decrease in overall part quality. As noted above, variations in irradiance can occur when light rays (photons) emitted from the fusing lamps strike a layer of build material in non-part areas that do not have fusing agent applied to them. Instead of being absorbed by the non-part areas of build material, such light rays can be reflected back up toward the fusing module. The back reflected light rays can then bounce off of reflective surfaces within the fusing module until they eventually travel back down to strike the layer of build material on “part areas” where fusing agent has been applied. Thus, certain parts can receive both an intended amount of irradiance based on an initial energy exposure from the fusing module, as well as an additional amount of irradiance based on a secondary exposure from back reflected light rays. In this way, the back reflections can result in an increased magnitude of irradiance being delivered to some parts. As noted above, increased irradiance can cause a part or certain portions or geometries of a part to overheat. When the build material for a part is overheated, it can cause additional surrounding build material to melt into the part, resulting in dimensional or other variations in the part.

From the above discussion, it should be evident that variations in irradiance on a given part can depend on the number, proximity, and geometries of other surrounding parts being formed within the build area. For example, in cases where the build area includes numerous parts that are isolated from one another, or that have no close neighboring parts, the back reflections coming off the non-part areas of build material can increase the magnitude of irradiance on the parts. Conversely, when numerous parts are more tightly packed within the build area in closer proximity to one another, the back reflections coming off the non-part areas of build material may not cause as much of an increase in the irradiance. This is because the nearby neighboring parts share the back reflected photons, resulting in a lower radiant exposure per part. Thus, the proximity of parts to one another within the build area can be a cause of irradiance variation that adversely impacts part quality.

The geometries or shapes of parts can also cause irradiance variations due to their effect on part proximities. As parts are being formed in a fusing-based 3D printing process, the part areas where fusing agent is printed can change with each successive build layer as they follow the part contours according to each successive 2D slice of the 3D part models. As the contours of each part change with each new layer, the proximity of the parts with respect to one another can also change. For example, two parts that get smaller and smaller with each build layer effectively move farther away from one another as each layer is processed. Because the proximity of parts to one another alters their exposure to back reflections off of non-part areas of build material, as noted above, the geometries or shapes of parts being formed together within the same build area can cause variations in the irradiance on the parts.

One prior method of reducing the variation in irradiance includes maintaining a certain minimum distance between parts within the build area. In some examples, for instance, the minimum recommended distance between parts in the build area that can help avoid irradiance variations can be in the range of about 10 to 15 millimeters. Greater distances between parts reduces the impact that the part geometries have on their relative proximities, which in turn reduces variations in irradiance on the parts as each layer of build material is processed. While adhering to a minimum distance in part separation can help to reduce irradiance variation, it has the drawback of limiting the packing density of parts within the build area. Thus, the increased distance between parts reduces the number of parts that can be processed with each build, which increases the overall cost per part.

Accordingly, example devices and methods for applying fusing energy within a 3D printing process described herein provide for a consistent application of fusing energy across all parts within a build area regardless of the number or configuration of the parts within the build area. A consistent application of fusing energy can be provided by an example fusing module designed to direct light energy onto layers of build material to fuse part areas, while at the same time minimizing or preventing light that reflects off of non-part areas from returning again to the build material.

An example fusing module serves as an enclosure that can include fusing lamps (thermic light sources) that emit and direct infra-red (IR) or near IR light, for example, in a downward direction toward a layer of build material that is spread over a print bed surface within a build area. The fusing module can also include an absorber to absorb light that reflects back off the build material in an upward direction to the fusing module. By absorbing the reflected light, the fusing module can reduce the effect of the back reflections, including irradiance variations. In some examples, the fusing module can reduce the effect of back reflections and irradiance variations by as much as 66%. The reduction in irradiance variation helps to improve dimensional consistency of parts, reduces variations in the material properties of parts, improves the cosmetic appearance of parts, and enables a higher part packing density within the build area of a 3D printing device which reduces part costs.

In a particular example, a fusing module for use in a 3D printing system includes a thermic source to emit light rays for heating a target zone. The fusing module also includes a reflector associated with the thermic source to reflect upward-emitted light rays in a downward direction toward the target zone, and an absorber positioned above the thermic source to absorb light rays that reflect off of the target zone.

In another example, a method of applying fusing energy in a 3D printing system includes providing build material in a build area, where the build material includes a part area printed with a fusing agent and a non-part area not printed with the fusing agent. The method also includes emitting light energy onto the build material from a thermic source, and absorbing light rays that reflect off of the non-part area of the build material.

In another example, a 3D printing system includes a fusing lamp to emit light rays to heat and melt an area of build material printed with a fusing agent, where the fusing agent is to absorb the light rays. The printing system also includes an absorber to absorb reflected light rays that reflect off of a bare area of the build material that is not printed with fusing agent.

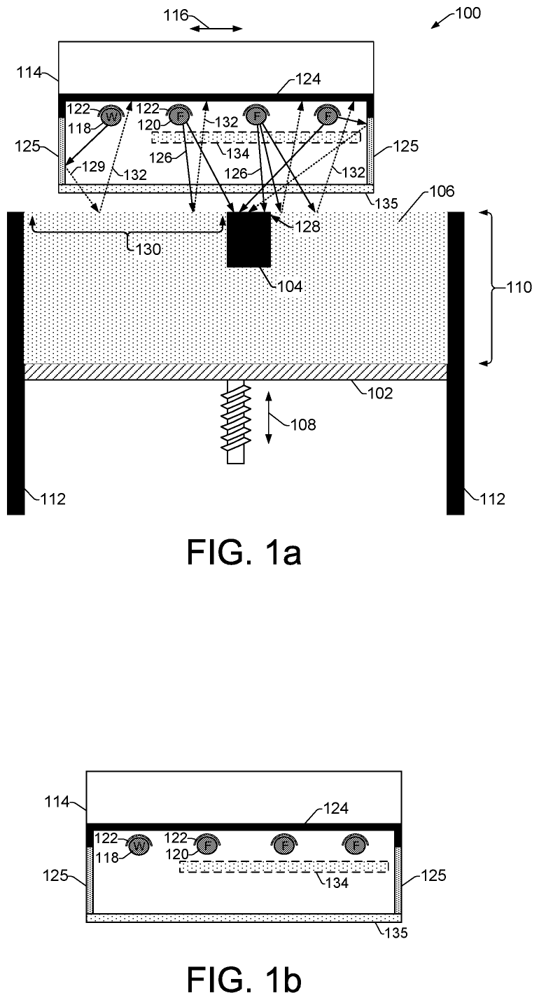

FIG. 1a shows a simplified block diagram of an example three-dimensional (3D) part-forming device 100, implemented as a 3D printer 100. The example 3D printer 100 may alternately be referred to herein as a 3D printing system 100. The example 3D printer 100 comprises a thermal fusion based 3D printer capable of forming, generating, or printing 3D parts through an additive build process that generally includes spreading layers of build material into a build area, printing a liquid fusing agent onto areas of each layer of build material, and applying fusing energy to each layer of build material to fuse the areas of printed build material together, forming a 3D part. While some components of an example 3D printer 100 are depicted in FIG. 1a and described herein, the printer 100 may include additional components that are not shown or that have been removed and/or modified. The absence of such other components is not intended to indicate a departure from the scope of the 3D printer 100 described herein.

As shown in FIG. 1a, an example 3D printer 100 can include a print bed 102 on which 3D objects or parts such as part 104 are to be formed from build material 106. The print bed 102 can alternately be referred to as a print platform, a build platform, and the like. The print bed 102 is mobile in a vertical direction (i.e., z-axis direction) as indicated by direction arrow 108. Parts can be formed in a layer-by-layer additive process within a three-dimensional space, or build area 110, that develops within printer walls 112 and above the print bed 102 as the print bed 102 moves vertically downward during the additive process. In some examples, the build material 106 can be contained in a cartridge, hopper or other build material source (not shown) and can be spread or applied onto the print bed 102, or onto a previously formed build material layer by a spreader (not shown) to form each build material layer.

The example 3D printer 100 can include a liquid agent dispenser (not shown) to print or otherwise apply a liquid fusing agent and detailing agent onto selective portions of layers of build material. In some examples, a liquid agent dispenser comprises one or multiple inkjet printheads. An example printhead can include a plurality of nozzles that extend across the width of the print bed 102 to eject a liquid, such as ink, water, or other liquid agent onto layers of build material layer 106. The liquid agent can comprise a fusing agent that acts as an energy absorber to facilitate heating of the build material when exposed to a fusing energy source such as a fusing lamp, for example. Liquid dispensing printheads can be implemented, for example, as thermal inkjet printheads or a piezoelectric printheads. The printheads can be coupled to a moveable carriage to facilitate their back and forth movement over the print bed 102 as they deposit liquid agents onto the build material.

The example 3D printer 100 can include a warming and heating lamp enclosure 114 referred to herein as a fusing module 114. In some examples, a fusing module 114 can comprise a stand-alone unit suitable for installation and/or replacement into other systems, such as a 3D printer 100. FIG. 1b shows an example of the fusing module 114 as a stand-alone unit. Referring now generally to FIGS. 1a and 1b, the fusing module 114 can be coupled to a moveable carriage (not shown) to enable bi-directional scanning of the fusing module 114 back and forth over a target zone such as the print bed 102 and/or build area 110. The fusing module 114 can scan in a generally horizontal direction (i.e., x-axis direction) as indicated by direction arrow 116.

The fusing module 114 can include thermic sources 118 and 120 that provide heating energy to a target zone. In general, a target zone to which a fusing module 114 may be applicable, can comprise any area in which build material can be processed in a 3D printing or 3D building process, such as the print bed 102 in the build area 110 of 3D printer 100. Thus, in a 3D printer 100, the fusing module 114 can provide heating energy to layers of build material 106 within the target zone of the print bed 102. The thermic sources can include a warming lamp (W) 118 and fusing lamp(s) (F) 120 comprising, for example, quartz-tungsten halogen lamps. A warming lamp (W) 118 can comprise, for example, a halogen lamp in the mid-IR (infrared) range (1.5-4.0 micron wavelength), while a fusing lamp 120 can comprise a halogen lamp in the near-IR range (0.76-1.5 micron wavelength). A warming lamp 118 can have a wavelength targeted to generally warm non-part build material, whereas a fusing lamp 120 can have a wavelength that is designed to be better absorbed by the fusing agent(s) used in the system. In some examples, a warming lamp 118 can comprise a halogen lamp with a color temperature at or about 1800 Kelvin, while a fusing lamp 120 can comprise a halogen lamp with a color temperature at or about 2700 Kelvin. Although one warming lamp (W) 118 and three fusing lamps (F) 120 are shown in FIGS. 1a and 1b, other numbers and/or arrangements of warming and fusing lamps are also possible and contemplated.

The warming and fusing lamps 118 and 120 can each include an associated reflector 122 to reflect upward-emitted light rays from the lamps. The reflectors 122 reflect the light rays back in a downward direction toward a target zone such as the build material 106 in build area 110. In some examples a reflector 122 can comprise an integrated reflective material that coats the inner top half of the surface of the lamp. A reflective material coating can include, for example, an aluminum oxide that forms a white ceramic coating on the inner top half of the surface of the lamp. In some examples a reflector 122 can comprise a discrete reflector component closely positioned to fit around a respective warming or fusing lamp. A discrete reflector component can include, for example, materials such as aluminum, silver, gold and other materials highly reflective of infrared light.

The fusing module 114 can also include an absorber 124 to absorb light rays reflected off of a target zone such as off of the surface of the build material 106. An absorber 124 can comprise, for example, a black anodized absorber such as aluminum, or a high temperature optical black paint or chromium based black that coats the inner walls of the fusing module 114. The absorber 124 can be located generally within the fusing module 114 above the lamps 118 and 120 and above the reflectors 122, and it can extend part way down a portion of the inner side walls of the fusing module 114. This placement of the absorber 124 within the fusing module 114 enables absorption of most of the reflected light rays that reflect off the surface of the target build material and are directed in an upward direction, while avoiding absorption of light rays that are directed downward toward the build material by the lamps 118 and 120, and by the reflectors 122, as further discussed below. The remaining portion of the inner side walls of the fusing module 114 that are not covered by the absorber 124, can comprise side wall reflectors 125. The side wall reflectors 125 generally serve to reflect light rays from lamps 118 and 120 in a downward direction toward the target zone (e.g., build material 106 in build area 110), as well as reflecting light rays that have reflected upward off of the target zone into the absorber 124.

As shown in FIG. 1a, light rays 126 (illustrated as straight line arrows 126) emitted from fusing lamp(s) 120 (and warming lamp 118) can strike part areas on the build material 106 that have been printed with fusing agent, such as the part area 128 associated with part 104 being formed within the build area 110. In some instances, light rays 126 emitted from the lamps 118 and 120 can first strike a side wall reflector 125 of the fusing module 114 before they strike the build material 106. Such reflected light rays can be referred to as first reflected light rays 129. Light rays 126 and first reflected light rays 129 that strike a printed part area 128 are absorbed by the printed build material, and they do not reflect off of the build material. However, light rays 126 and first reflected light rays 129 can also strike non-part areas of the build material 106 that is bare material that has not been printed with fusing agent, such as the non-part area 130 located next to the part 104. As shown in FIG. 1a, light rays 126 and first reflected light rays 129 that strike a non-part area 130 do not get absorbed by the build material, but are instead reflected off the surface of the build material as reflected rays 132 (illustrated in FIG. 1a as dashed line arrows 132).

As shown in FIG. 1a, the reflected rays 132 that bounce off the non-part surface areas of the build material, such as the non-part area 130, reflect generally in an upward direction back into the fusing module 114. It is these reflected rays 132 that the absorber 124 effectively terminates and prevents from returning to or recycling back to the build material. But for their absorption and termination by the absorber 124, the reflected rays 132 might otherwise continue to reflect off surfaces within the fusing module 114 and eventually return to the build material where they could contribute to variations in irradiance on parts within the build area 110.

As shown in FIGS. 1a and 1b, an example fusing module 114 can additionally include a borosilicate glass element 134 positioned under the fusing lamps 120. The positioning of the borosilicate glass element 134 within the fusing module 114 helps to ensure that light rays 126 emitted from the fusing lamps 120 pass through the borosilicate glass element 134 on their way to a target zone such as the build material 106 in 3D printer 100. The borosilicate glass element 134 can serve as a filter to prevent some wavelengths of light emitted from the fusing lamps 120 from reaching the build material. In some examples, therefore, the borosilicate glass element 134 enables an increase in power from the fusing lamps 120 to improve the fusing/melting of a part without also overheating the build material that is adjacent to the part. In some examples, the fusing module 114 can additionally include a bottom wall enclosure 135 comprising, for example, fuzed quartz.

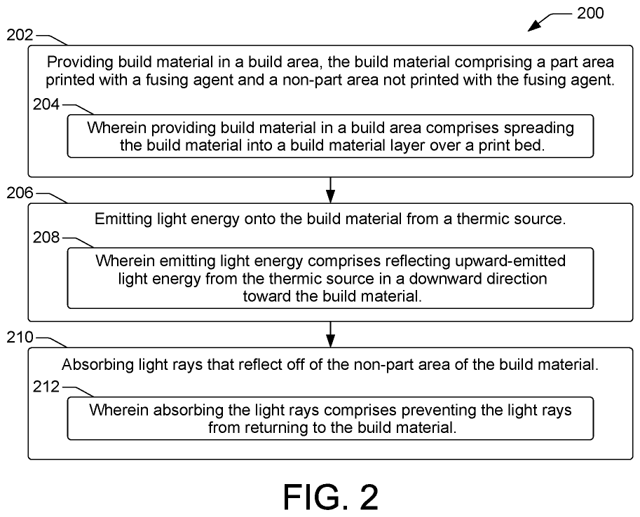

FIG. 2 shows a flow diagram of an example method 200 of applying fusing energy in a 3D printing system. The example method 200 is associated with examples discussed above with respect to the example 3D printer and fusing module 114 of FIGS. 1a and 1b, and details of the operations shown in method 200 can be found in the related discussion of such examples. The method 200 may include more than one implementation, and different implementations of method 200 may not employ every operation presented in the flow diagram of FIG. 2. Therefore, while the operations of method 200 are presented in a particular order within the flow diagram, the order of their presentation is not intended to be a limitation as to the order in which the operations may actually be implemented, or as to whether all of the operations may be implemented. For example, one implementation of method 200 might be achieved through the performance of a number of initial operations, without performing some subsequent operations, while another implementation of method 200 might be achieved through the performance of all of the operations.

Referring now to the flow diagram of FIG. 2, an example method of applying fusing energy in a 3D printing system can begin with providing build material in a build area, where the build material comprises a part area printed with a fusing agent and a non-part area not printed with the fusing agent, as shown at block 202. In some examples, as shown at block 204, providing build material in a build area comprises spreading the build material into a build material layer over a print bed. The method 200 can continue at block 206 with emitting light energy onto the build material from a thermic source. In some examples, as shown at block 208, emitting light energy comprises reflecting upward-emitted light energy from the thermic source in a downward direction toward the build material. The method 200 can continue at block 210 with absorbing light rays that reflect off of the non-part area of the build material. In some examples, absorbing the light rays comprises preventing the light rays from returning to the build material, as shown at block 212.

What is claimed is:

1. A fusing module for use in a 3D printing system comprising:
a thermic source to emit light rays for heating a target zone;
a reflector associated with the thermic source to reflect upward-emitted light rays in a downward direction toward the target zone; and,
an absorber positioned above the thermic source to absorb light rays that reflect off of the target zone.

2. A fusing module as in claim 1, wherein the absorber is also positioned along a first portion of a side wall of the fusing module, and wherein a second portion of the side wall comprises a side wall reflector to reflect light rays from the thermic source toward the target zone.

3. A fusing module as in claim 1, wherein the thermic source comprises a warming lamp and multiple fusing lamps.

4. A fusing module as in claim 3, wherein the warming lamp and the fusing lamps comprise quartz halogen lamps.

5. A fusing module as in claim 4, wherein the warming lamp comprises a color temperature on the order or 1800 Kelvin and the fusing lamps comprise a color temperature on the order of 2700 Kelvin.

6. A fusing module as in claim 3, wherein the reflector comprises a reflector selected from a reflective coating that coats a portion of a lamp, and a discrete reflector device positioned outside of a lamp.

7. A fusing module as in claim 3, further comprising a borosilicate filter positioned between the fusing lamps and the target zone to filter wavelengths from light rays directed to strike build material within the target zone.

8. A fusing module as in claim 1, wherein the absorber comprises an infra-red light absorber selected from a black anodized absorber, a high temperature optical black paint coated absorber, and a chromium based black absorber.

9. A fusing module as in claim 1, wherein the module comprises a bi-directional scanning module to scan back and forth over the target zone.

10. A method of applying fusing energy in a 3D printing system comprising:
providing build material in a build area, the build material comprising a part area printed with a fusing agent and a non-part area not printed with the fusing agent;
emitting light energy onto the build material from a thermic source; and,
absorbing light rays that reflect off of the non-part area of the build material.

11. A method as in claim 10, wherein absorbing the light rays comprises preventing the light rays from returning to the build material.

12. A method as in claim 10, wherein emitting light energy comprises reflecting upward-emitted light energy from the thermic source in a downward direction toward the build material.

13. A method as in claim 10, wherein providing build material in a build area comprises spreading the build material into a build material layer over a print bed.

14. A 3D printing system comprising:
a fusing lamp to emit light rays to heat and melt an area of build material printed with a fusing agent to absorb the light rays; and,
an absorber to absorb reflected light rays that reflect off of a bare area of the build material that is not printed with fusing agent.

15. A 3D printing system as in claim 14, further comprising:
an enclosure to convey the fusing lamp and absorber back and forth over a build platform that comprises a layer of the build material.
